(19) United States
(12) Patent Application Publication
(10) Pub. No.: US 2026/0154389 A1
(43) Pub. Date: Jun. 4, 2026

(54) INFORMATION PROCESSING DEVICE, INFORMATION PROCESSING METHOD, AND STORAGE MEDIUM

(71) Applicant: CANON KABUSHIKI KAISHA, Tokyo (JP)

(72) Inventor: JUN YAMAMOTO, Tokyo (JP)

(21) Appl. No.: 19/369,439

(22) Filed: Oct. 27, 2025

(30) Foreign Application Priority Data
Dec. 3, 2024 (JP) 2024-210073

(51) Int. Cl. G06F 21/32; G06V 10/14; G06V 40/16; H04N 23/55; H04N 23/611

(52) U.S. Cl. CPC G06F 21/32; G06V 10/14; G06V 40/172; H04N 23/55; H04N 23/611

(57) ABSTRACT

An information processing device includes: a captured image acquiring unit configured to acquire a captured image; at least one memory storing instructions; and at least one processor executing the stored instructions causing the information processing device to: perform first image-capturer authentication at the time of the captured image not being captured; perform second image-capturer authentication at the time of the captured image being captured; and assign authentication information of an image-capturer to the captured image on the basis of results of the first and second image-capturer authentication. Executing the stored instructions by the processor further causes the information processing device to: in a case where only the second image-capturer authentication has been performed, perform the first image-capturer authentication within a valid period of the second image-capturer authentication set after the second image-capturer authentication; and assign the authentication information when the image-capturer is identified through the first image-capturer authentication.

### BACKGROUND

### Field of the Technology

The present disclosure relates to an information processing device that personally authenticates a user and, more particularly, relates to an information processing device that grants image-capturer authentication to a captured image acquired by an imaging device.

### Description of the Related Art

With the spread of images generated and processed using artificial intelligence (AI), technologies for assuring the authenticity of captured images become necessary. In camera systems, for example, technologies for digitally signing authentication information assigned to each camera onto a captured image to render it incapable of being altered are known. In accordance with this, the image is ensured to be an image captured by the camera.

In addition to such technologies, information of an image-capturer can be assigned to a captured image to render it incapable of being altered (also referred to as image-capturer authenticity guarantee). For example, in Japanese Unexamined Patent Laid-Open No. 2003-204427, it is disclosed that an image of the image-capturer's eyeball looking into the viewfinder at the time of image-capturing is acquired, and image-capturer information is recorded together with image data through personal authentication using analysis of iris information.

However, as in Japanese Patent Laid-Open No. 2003-204427, in a case in which personal authentication of an image-capturer is performed on the basis of information of an eyeball image at the time of an image-capturing operation, there are the following problems. At the time of an image-capturing operation, the image-capturer's attention is directed toward image-capturing rather than toward authentication. An eyeball image varies greatly depending on how the eye is placed against the viewfinder and the direction of a visual line, and it cannot be determined that the eyeball image necessarily becomes an image that is appropriate for authentication. There is a concern about cases in which personal authentication repeatedly fails in accordance with a decrease in the authentication accuracy, and image-capturer information is not assigned.

Furthermore, in a case in which the threshold value of the authentication accuracy is decreased in order to avoid the situation of repeated failures, the reliability of personal authentication decreases. On the other hand, in a case in which an eyeball image appropriate for authentication is configured to be acquired at the time of an image-capturing operation for raising the authentication accuracy, operations accompanying authentication cause a time lag, and it leads to a loss in the image-capturing opportunities, particularly in an image-capturing scene in which changes in the subject are large.

### SUMMARY

The present disclosure is in view of the problems described above, and the present disclosure is directed to provide an information processing device, an information processing method, and a storage medium capable of ensuring sufficient reliability for granting image-capturer authentication while preventing a loss in image-capturing opportunities due to authentication processing.

According to an aspect of the present disclosure, an information processing device includes: a captured image acquiring unit configured to acquire a captured image; at least one memory storing instructions; and at least one processor executing the stored instructions causing the information processing device to: perform first image-capturer authentication at the time of the captured image not being captured; perform second image-capturer authentication at the time of the captured image being captured; and assign authentication information of an image-capturer to the captured image acquired by the captured image acquiring unit on the basis of a result of the first image-capturer authentication and a result of the second image-capturer authentication. Executing the stored instructions by the processor further causes the information processing device to: in a case in which the second image-capturer authentication has been performed without performing the first image-capturer authentication, perform the first image-capturer authentication within a valid period of the second image-capturer authentication that is set after the second image-capturer authentication; and assign the authentication information when the image-capturer is able to be identified through the first image-capturer authentication.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an example of a mechanical structure of a first embodiment of the present disclosure.

FIG. 2 is a block diagram illustrating an example of the functional configuration of the first embodiment of the present disclosure.

FIG. 3 is a schematic flowchart illustrating the flow of a process of the first embodiment of the present disclosure.

FIGS. 4A and 4B are schematic diagrams illustrating an authentication method according to the first embodiment of the present disclosure.

FIG. 5 is a schematic diagram illustrating another authentication method according to the first embodiment of the present disclosure.

FIG. 6 is a block diagram illustrating an example of the functional configuration according to a second embodiment of the present disclosure.

FIG. 7 is a schematic diagram illustrating an authentication method according to the second embodiment of the present disclosure.

FIGS. 8A to 8D are schematic diagrams illustrating examples of display for authentication according to a third embodiment of the present disclosure.

FIGS. 9A to 9D are schematic diagrams illustrating examples of display for another authentication according to the third embodiment of the present disclosure.

### DESCRIPTION OF THE EMBODIMENTS

Hereinafter, embodiments of the present disclosure will be described with reference to the attached drawings. The present disclosure is not limited to situations described below, and any embodiment consistent with the spirit of the present disclosure is applicable.

### First Embodiment

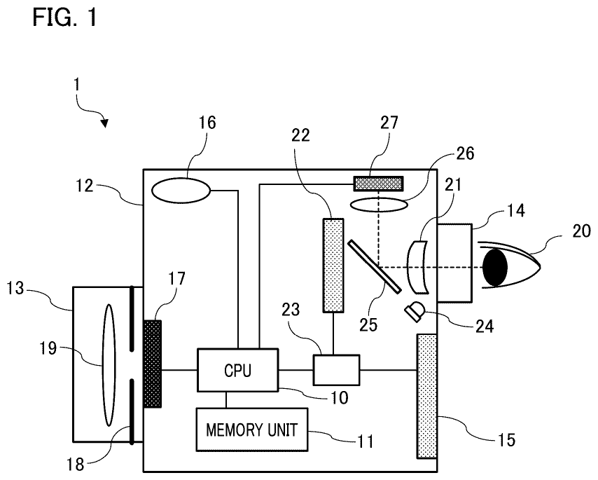

FIG. 1 illustrates an example of the mechanical structure of a camera system 1 including an information processing device according to this embodiment. In this embodiment, a mirrorless camera will be used as the camera system 1 for description. However, the embodiment is not limited to the camera system, and any information device having a similar function is applicable.

The camera system 1 has necessary camera mechanisms such as a camera body 12, a lens 13, an electronic viewfinder 14, a touch panel display 15, a release button 16, and an imaging element 17. The lens 13 has an aperture mechanism 18 and a focusing mechanism 19, and external information is collected onto the imaging element 17 through the lens 13 by controlling these mechanisms. The external information is acquired and stored as electronic data by the imaging element 17 in accordance with an operation of the release button 16 as a trigger.

In the touch panel display 15 and an electronic viewfinder display 22, a captured image stored in a memory unit 11 or external information (a live-view) output by the imaging element 17 at the time of not image-capturing can be displayed through a display driving circuit 23. An image-capturer can check a video displayed in the electronic viewfinder display 22 through an eyepiece lens 21 by looking into the electronic viewfinder 14.

In addition, the camera system 1 can acquire also an image of the image-capturer's eyeball 20 (hereinafter referred to as an eyeball image) looking into the electronic viewfinder 14. The eyeball image is acquired and stored, for example, by branching a part of optical information of the inside of the electronic viewfinder 14 using an optical splitter 25 and collecting the branched optical information onto an eyeball imaging element 27 using a light receiving lens 26. In a case in which optical information is directly collected in accordance with the arrangement of the eyeball imaging element 27, the optical splitter 25 can be omitted. Furthermore, for the optical information of the eyeball, light ranging from visible light to infrared light can be appropriately used.

In a case in which the camera system 1 further has a visual line detection function, particularly in a case in which visual line detection is performed using a corneal reflection method using Purkinje images, infrared light, which generally does not interfere with a normal field of vision, is used. In that case, an illumination light source 24 emits infrared light, and a sensor having sensitivity for infrared light is used as the eyeball imaging element 27.

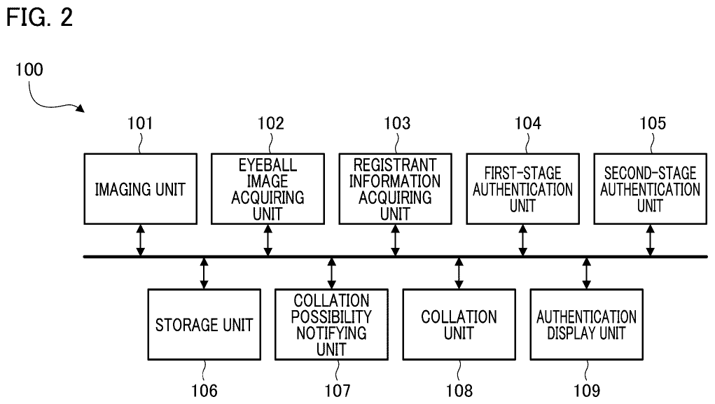

FIG. 2 illustrates an example of the functional configuration of an information processing device 100 included in the camera system 1 according to this embodiment. A central processing unit 10 (hereinafter, referred to as a CPU) illustrated in FIG. 1 functions as some of units described below or controls each of the units. In addition, the memory unit 11 accompanying the CPU 10 has a function of storing each piece of data output from each unit and the like. The data of the memory unit 11 can be output to each unit through the CPU 10.

In FIG. 1, the imaging unit 101 has a function for imaging external information, and the imaging element 17 and the like correspond thereto. In other words, the imaging unit 101 functions as a captured image acquiring unit that acquires a captured image. The eyeball image acquiring unit 102 has a function of capturing an eyeball image, and the eyeball imaging element 27 and the like illustrated in FIG. 1 correspond thereto. Signal voltages from a plurality of pixels included in a CCD or a CMOS configuring the imaging element 17 and the eyeball imaging element 27 are converted from analog to digital and then are output to the CPU 10. The CPU 10 can acquire external information and an eyeball image from input signals of a plurality of pixels.

In addition, in order to determine a state in which an eyeball image can be acquired, the eyeball image acquiring unit 102 includes a proximity sensor that detects an eye-on/eye-off state of an image-capturer for the electronic viewfinder 14. While the proximity sensor detects eye-on, an eyeball image can be acquired, and biometric authentication using the eyeball image can be executed.

A registrant information acquiring unit 103 registers authentication information of a person who is scheduled to become a user in the camera system 1 in advance (hereinafter, a person whose authentication information has been registered is referred to as a “registrant”). A registrant is granted the authority to perform image-capturer authentication. A registrant may be a single person or may be multiple persons sharing the camera system 1. In addition to personal information such as a name and the like, the authentication information of a registrant includes biometric information (registrant characteristics) used for authentication. Examples of the biometric information include characteristic information acquired from fingerprint information and a face image and the like in addition to characteristics acquired from an eyeball image. The authentication information may be non-biometric information such as a passcode set to each registrant or the like. In FIG. 1, the CPU 10 corresponds to the registrant information acquiring unit 103, and the authentication information of a registrant, for example, may be stored in the memory unit 11.

In this embodiment, after registrants of the camera system 1, for example, are specified as “Mr. A” or limited to “several persons including Mr. A”, authentication information (registrant characteristics) of these registrants is acquired. For this, in advance, authentication information of persons who become registrants including Mr. A may be registered in the memory unit 11 of the camera system 1 or may be read from an external memory such as a CF card in which authentication information of persons who become registrants including Mr. A is registered.

In addition, the registrant characteristics described above need to be values that are collatable by a collation unit 108 to be described below with user characteristics to be described below. Typically, the registrant characteristics can be acquired using the same calculation method or the same measurement method as that for the user characteristics.

In the specifying and limiting of registrants, for example, a registrant may select his or her own data from a registrant list through a camera menu operation. In other words, by operating physical buttons provided on a body 12, a touch panel display 15, or the like, registrants can be specified. Furthermore, the method of identifying and limiting registrants is not limited to the camera menu operation and can be appropriately selected through inputting of a password used by a person or a group, reading of an ID card, or the like.

In this embodiment, it is premised that the registrant information is correct, and the authentication of a user (image-capturer) of the camera system 1 is performed by collating these registrant characteristics with user characteristics acquired from a user. In a case in which the user characteristics are similar to the registrant characteristics, it is judged (authenticated) that the user (image-capturer) is the registrant. In this embodiment, a user represents a person who is actually using the camera system 1 (also referred to as an image-capturer). Furthermore, a user may be a person who is different from a registrant.

A first-stage authentication unit 104 acquires authentication information for first-stage authentication (first image-capturer authentication) that is performed at the time of not image-capturing. The first-stage authentication may use an authentication method using biometric information of a user (image-capturer) or may use an authentication method using non-biometric information such as a passcode or the like. In FIG. 1, the CPU 10 corresponds to the first-stage authentication unit 104.

In the case of the authentication method using biometric information, the first-stage authentication unit 104 extracts information (user characteristics) that can be used for specifying an individual user, for example, such as a characteristic quantity, a characteristic vector, and the like from an eyeball image as authentication information. The user characteristics based on the eyeball images have properties in which, in a case in which there are a plurality of eyeball images of the same person, characteristic quantities calculated from any of the images have a high degree of similarity, and a degree of similarity of characteristic quantities calculated from eyeball images of different persons is low. Thus, a user (image-capturer) can be identified from collation between the user characteristics and the registrant characteristics in the collation unit 108 to be described below.

In order to improve the authentication accuracy, the authentication operation may be instructed and guided in a calibration-like manner so as to acquire eyeball images that are easier to authenticate. Since the characteristics extraction is a well-known technology in fields such as object recognition, face recognition, and iris authentication, details are omitted here.

Furthermore, as an authentication method using biometric information, a fingerprint authentication mechanism not illustrated in the drawing other than eyeball images may be used, and, for example, a face detection mechanism that detects a user's face image captured by an in-camera, which is not illustrated in the drawing, disposed on the rear side of a body 12 may be used. In such cases, a user does not necessarily need to look into the electronic viewfinder 14, and characteristics extraction is performed using the fingerprint or the face image.

In the case of the authentication method using non-biometric information, a passcode that is individually set to each registrant may be input and acquired from physical buttons, the touch panel display 15, or the like as authentication information. In a case in which the camera system 1 can access a network environment, by causing an information communication device such as a smartphone owned by a user to transmit a passkey of the camera system 1 in real time, personal authentication may be performed using the input of this passkey.

The first-stage authentication performed by the first-stage authentication unit 104, compared to second-stage authentication to be described below, is a process requiring a time dedicated to authentication and has a high identification accuracy for authenticating a user as a registrant as its feature. For this reason, in a case in which a user is identified once, thereafter, the first-stage authenticated state may be maintained within a valid period that is arbitrary set. This valid period of the first-stage authentication can be appropriately set such as a period until an arbitrary time elapses, a period until the power of the camera system 1 is turned off, a period until the user of the camera system 1 is changed even when the power is not turned off, or the like. The valid period of the first-stage authentication is set to a period that is longer than the valid period of the second-stage authentication to be described below.

A second-stage authentication unit 105 acquires authentication information of the second-stage authentication (second image-capturer authentication) that is performed at the time of image-capturing. In this embodiment, the second-stage authentication uses an authentication method using biometric information of an image-capturer, particularly, eyeball images. In FIG. 1, the CPU 10 corresponds to the second-stage authentication unit 105.

Most captured images can be considered to have been captured by a user identified by the first-stage authentication unit 104, but there is no limitation to this case. For example, a case in which another person temporarily takes over the image-capturing at an image-capturing site and the like may be assumed. In order to correctly determine that that a captured image has been captured by a user (for example, Mr. A) identified by the first-stage authentication unit 104, it is necessary to acquire information of a user (image-capturer) at the moment of image-capturing and determine that the image-capturer is Mr. A on the basis of the information.

Thus, in this embodiment, at the moment of image-capturing or almost simultaneously therewith, the eyeball image acquiring unit 102 acquires eyeball images of an image-capturer (user) and extracts user characteristics from the eyeball images using the second-stage authentication unit 105. In a case in which an authentication processing time is sufficiently shorter than an image-capturing interval and does not affect a next image-capturing operation, user characteristics may be extracted for every eyeball image acquisition timing in the second-stage authentication. On the other hand, in a case in which a time for extracting user characteristics is insufficient between frames due to image-capturing operations for continuous image-capturing or the like, an eyeball image may be stored together with a captured image, and user characteristics may be extracted from the eyeball image stored after the end of the image-capturing operation.

The user characteristics used in the second-stage authentication are the same as those described above in the first-stage authentication unit 104, and by collating the user characteristics with the registrant characteristics, enable identification of a person similar to the registrant of the camera system 1. Compared with the first-stage authentication, since eyeball images acquired during an image-capturing operation are used in the second-stage authentication, the eyeball images are not necessarily appropriate for authentication, and the identification accuracy becomes relatively low. In other words, the person identification accuracy of the second image-capturer authentication is lower than the person identification accuracy of the first image-capturer authentication.

Thereafter, the captured images for which users (image-capturers) have been identified are maintained in a state in which the second-stage authentication has been achieved within a valid period that has been arbitrarily set. However, since the identification accuracy of the authentication is relatively low, the valid period of the second-stage authentication is set to be shorter than the valid period of the first-stage authentication.

As an example of the valid period of the second-stage authentication, it may be set to a valid period, which begins with the execution of the second-stage authentication in a certain image-capturing operation, until when the image-capturing operation ends, the eye has been taken off the electronic viewfinder 14, and the eye has been placed on the electronic viewfinder 14 once more for a next image-capturing operation.

In addition, as another example of the valid period of the second-stage authentication, it may be set to a valid period until when the release button 16 is pressed for next image-capturing regardless of eye-on/eye-off after an image-capturing operation ends, and the eye has been off the electronic viewfinder 14 once. The detection of the eye-on state for the electronic viewfinder 14 can be performed using the proximity sensor described above or the like.

Furthermore, although the second-stage authentication in the second-stage authentication unit 105 is assumed to extract user characteristics from eyeball images, user's fingerprint authentication information at the time of image-capturing can be also used. For example, at the timing of image-capturing, a user presses the release button 16. If a sensor or the like acquiring the fingerprint information of a user's finger placed on the release button 16 is provided, the biometric information of a user (image-capturer) at the time of image-capturing can be acquired. Although the acquired fingerprint information may replace the user characteristics acquired from the eyeball image, both may also be used together to further improve the authentication accuracy.

The user characteristics acquired by the second-stage authentication unit 105 described above are stored in the storage unit 106 in association with captured images that have been simultaneously captured.

The storage unit 106 maintains (stores) the captured image and the information (the user characteristics) acquired by the second-stage authentication unit 105. In this embodiment, the memory unit 11 corresponds to the storage unit 106. In addition, such information may be stored in an external memory such that it can be extracted from the camera system 1. Examples of the external memory include a detachable recording medium such as an SD card, a CF card, an external storage such as a USB memory, a storage on a cloud that can be accessed through a network, and the like.

The association between the captured image and the information acquired by the second-stage authentication unit 105 at the time of storing them in the storage unit 106 is performed, for example, through assignment and management of a hash value that is an ID unique to a file. As the hash value, hash values of the captured image and the eyeball information may be managed together, or the hash value may be assigned by including the image-capturer information and the eyeball information in the captured image as one file.

A hash value is a fixed-length value calculated for data having an arbitrary length and is designed such that it is a different value for different original data. In principle, although it may occur that a plurality of pieces of data has the same hash value (collision between hash values), such a situation does not actually occur, which does not cause any problem. Moreover, since it is difficult to generate data that results in a specific hash value, it is assumed to be impossible to replace a captured image associated with eyeball information with another image. Hash values can be calculated, for example, using technologies of SHA256 and the like.

A collation possibility notifying unit 107 gives a notification to the collation unit 108 under the following two conditions. In FIG. 1, the CPU 10 corresponds to the collation possibility notifying unit 107. A first condition is a case in which registrant characteristics acquired by the registrant information acquiring unit 103 are present, and user characteristics acquired by the first-stage authentication unit 104 are present. In a case in which this condition is satisfied, the collation possibility notifying unit 107 notifies the collation unit 108 such that it performs first-stage authentication judgment.

A second condition is a case in which registrant characteristics acquired by the registrant information acquiring unit 103 are present, and user characteristics acquired by the second-stage authentication unit 105 are present in association with the captured image. In a case in which this condition is satisfied, the collation possibility notifying unit 107 notifies the collation unit 108 such that it performs second-stage authentication judgment.

The collation unit 108 judges whether or not the user is the same person who is a person registered as a registrant by collating the registrant characteristics with the user characteristics. The collation is performed in each of the first-stage authentication and the second-stage authentication. As described above, while the registrant characteristics represent information stored in the camera system 1, the user characteristics represent information that is stored in association with each captured image. In FIG. 1, the CPU 10 corresponds to the collation unit 108.

For each user characteristics, the collation unit 108 compares (collates) the registrant characteristics with the user characteristics and determines the authentication to be successful in a case in which the degree of similarity is a predetermined value or more. In a case in which a plurality of pieces of registrant information are present, it may be judged whether or not a highest degree of similarity is a predetermined value or more. Thus, in a case in which the registrant characteristics are collated with the user characteristics acquired by the first-stage authentication unit 104, the first-stage authentication unit 104 and the collation unit 108 function as a first authentication unit that performs the first image-capturer authentication at the time of not image-capturing. In addition, in a case in which the registrant characteristics are collated with the user characteristics acquired by the second-stage authentication unit 105, the second-stage authentication unit 105 and the collation unit 108 function as a second authentication unit that performs the second image-capturer authentication at the time of image-capturing.

In a case in which a user (image-capturer), whose first-stage authentication has been successful, judged to be a registrant, and an image-capturer of a captured image, whose second-stage authentication has been successful, judged to be a registrant are the same person, the collation unit 108 performs a predetermined operation. An example of the predetermined operation includes assigning of information of a user (image-capturer) to a captured image to be unable to be altered (granting image-capturer authentication). By configuring as such, it a person who has captured a captured image can be assured (authenticity assurance). In other words, the collation unit 108 functions as an information assigning unit that assigns authentication information of an image-capturer to a captured image acquired by the captured image acquiring unit on the basis of the result of the first image-capturer authentication and the result of the second image-capturer authentication.

In order to assign information to be unable to be altered, for example, a digital signature technology may be used. A digital signature is a technology capable of proving that data has not been altered from a signature assignment time point and is widely known, and thus details thereof are omitted.

An authentication display unit 109 performs status notification of the first-stage authentication and the second-stage authentication and the like. The touch panel display 15 and the electronic viewfinder display 22 illustrated in FIG. 1 correspond to the authentication display unit 109. When the first-stage authentication has not been executed, the authentication display unit 109 gives a notification of a non-executed status. By checking the notification, the user can instruct execution of the first-stage authentication.

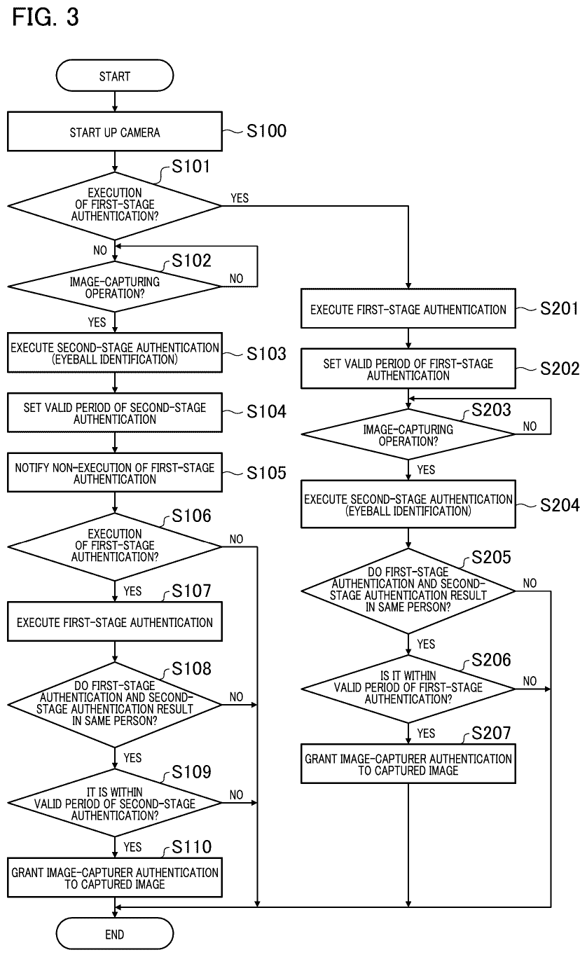

FIG. 3 is a schematic flowchart illustrating the flow of the process (an information processing method) of the information processing device 100 according to this embodiment. Steps S100 to S110 illustrated in FIG. 3 represent operations of a case in which the second-stage authentication is performed first, and Steps S201 to S207 represent operations of a case in which the first-stage authentication is performed first. Each of the following processes illustrated in FIG. 3 is realized, for example, by the CPU 10 executing a program stored in the memory unit 11. By adding “S” to the beginning of each process (step) in the denotation, the denotation of the process (step) is omitted.

In the camera system 1, at a normal time, although the first-stage authentication is assumed to be performed before the second-stage authentication, there are cases in which, after the camera system 1 has been started to operate, there is no time to perform the first-stage authentication, and immediate image-capturing is desired. This embodiment is in view of such cases, and a sequence in which the first-stage authentication is performed after the second-stage authentication is described.

In this embodiment, performing of the first-stage authentication after the second-stage authentication means subsequently performing of the first-stage authentication within the valid period of the second-stage authentication. For example, when the user moves his or her eye away from the electronic viewfinder 14 after the second-stage authentication, the camera system 1 notifies the user that the first-stage authentication has not been executed and prompts the user to execute the first-stage authentication as needed.

First, operations of a case in which the first-stage authentication is performed first are described. After the camera system 1 is started to operate in S100, a user determines whether to execute the first-stage authentication in S101. The determination of execution, for example, may be performed by detecting that the user has selected the execution of the first-stage authentication from a menu displayed on the touch panel display 15 or the like or that the user has pressed a function button disposed on the body 12 to which execution of the first-stage authentication has been assigned. In addition, the camera system 1 may give notification to prompt the execution of the first-stage authentication.

When the user selects the execution of the first-stage authentication, the process proceeds to S201, and the first-stage authentication is executed. In other words, user characteristics are acquired by the first-stage authentication unit 104, the acquired user characteristics are collated with the registrant characteristics by the collation unit 108, and it is authenticated that the user is a registrant. When the first-stage authentication is successful, and it is identified that the user is a registrant, the valid period of the first-stage authentication is set in S202.

Thereafter, when the user (image-capturer) looks into the electronic viewfinder 14 and enters an image-capturing operation (S203: Yes), an eyeball image is acquired, and the second-stage authentication is executed (S204). In other words, user characteristics are acquired by the second-stage authentication unit 105, the acquired user characteristics are collated with registrant characteristics by the collation unit 108, and it is authenticated that the user is a registrant. When it is identified that the user is a registrant in accordance with a success of the second-stage authentication, the collation unit 108 judges whether the person identified through the first-stage authentication and the person identified through the second-stage authentication are the same person (S205). In a case in which it has been judged that the persons are the same person in S205 (S205: Yes), and it is within the valid period of the first-stage authentication (S206: Yes), the collation unit 108 grants image-capturer authentication to the captured image (S207).

In other words, in a case in which the first image-capturer authentication has been performed, and the image-capturer has been identified through this first image-capturer authentication, when the second image-capturer authentication is performed within the valid period of the first image-capturer authentication that has been set after the first image-capturer authentication, the collation unit 108 grants authentication information.

Next, operations of a case in which the second-stage authentication is performed first are described. After the camera system 1 has been started to operate in S100, the user determines whether the first-stage authentication is to be executed in S101. For the determination of the execution, as described above, the pressing of the menu selection, a function button, or the like may be detected.

The user does not select the execution of the first-stage authentication and, for example, cancels the menu display to return to the live view display or places his or her eye on the electronic viewfinder 14 to enter the image-capturing operation (S102: Yes). Then, when the release button 16 is pressed in a state in which the eye is place on the electronic viewfinder 14, the second-stage authentication is executed by the second-stage authentication unit 105 (S103).

In the second state authentication of S103, as described above, user characteristics extracted from an eyeball image are stored in association with each captured image. Then, at the timing of the end of image-capturing, the registrant characteristics are compared (collated) with each user characteristics, and in a case in which the degree of similarity has a predetermined value or more, the second-stage authentication is determined to be successful, and the user (image-capturer) is identified. However, in the second-stage authentication, since the eyeball image is not necessarily an image that is appropriate for authentication, there is a possibility of a case in which the degree of similarity does not reach a predetermined value or more to cause the authentication to fail or a case in which an incorrect person is identified occurring depending on the user characteristics.

For this reason, in this embodiment, in a case in which the image-capturer of the captured image of which the second-stage authentication has been successful and a user identified in the first-stage authentication additionally executed within the valid period of the second-stage authentication after the second-stage authentication are authenticated to be the same person, image-capturer authentication is granted to the captured image.

Next, the valid period of the second-stage authentication is set in S104. The valid period of the second-stage authentication is set to expect that the first-stage authentication is subsequently executed within this valid period. Although the valid period of the second-stage authentication may be set to an arbitrary period, compared to the first-stage authentication, the identification accuracy of the authentication is relatively low, and thus the valid period is set to be shorter than the valid period of the first-stage authentication.

Next, a non-execution state of the first-stage authentication is notified to the user in S105. For example, when the eye is away from the electronic viewfinder 14, the camera system 1 notifies the user that the first-stage authentication has not been executed.

In a case in which the user requests granting of the image-capturer authentication to the captured image acquired in prior image-capturing, the execution of the first-stage authentication is selected (S106: Yes), and the process proceeds to S107. In S107, the first-stage authentication is executed to identify the user. In other words, similar to S201, user characteristics are acquired by the first-stage authentication unit 104, and the acquired user characteristics are collated with the registrant characteristics by the collation unit 108 to authenticate that the user is a registrant.

In S108, similar to S205, it is judged whether the person identified in the first-stage authentication and the person identified in the second-stage authentication that has already been executed are the same person.

In a case in which it has been judged that the persons are the same person in S108 (S108: Yes), and it is within the valid period of the second-stage authentication (S109: Yes), the image-capturer authentication is granted to the captured image (S110). In addition, when the first-stage authentication of S107 is performed once, authentication for an image-capturing operation performed thereafter may follow S201 to S207.

According to the flowchart illustrated in FIG. 3, the first-stage authentication is executed within the valid period of the second-stage authentication. Then, in a case in which the user identified through the first-stage authentication and the user (image-capturer) identified through the second-stage authentication that has been executed in advance are judged to be the same person, image-capturer authentication is granted to the captured image that has been acquired until then.

On the other hand, in a case in which the first-stage authentication is not executed within the valid period of the second-stage authentication, and the user places his or her eye on the electronic viewfinder 14 again, the captured image maintaining the state in which the previous second-stage authentication has been achieved is excluded from targets for granting image-capturer authentication. Alternatively, in a case in which the valid period of the second-stage authentication is ended by pressing the release button 16, the captured image maintaining the state in which the previous second-stage authentication has been achieved is excluded from targets for granting image-capturer authentication.

In other words, in a case in which the second image-capturer authentication is performed by the second authentication unit without performing the first image-capturer authentication using the first authentication unit, the collation unit 108 operates as follows. When the first image-capturer authentication is performed within the valid period of the second image-capturer authentication that has been set after the second image-capturer authentication, the collation unit 108 grants authentication information.

According to the flowchart illustrated in FIG. 3, S102 functions as a captured image acquiring process, S103 functions as a second authentication process, S107 functions as a first authentication process, and S108 to S110 function as an information assigning process.

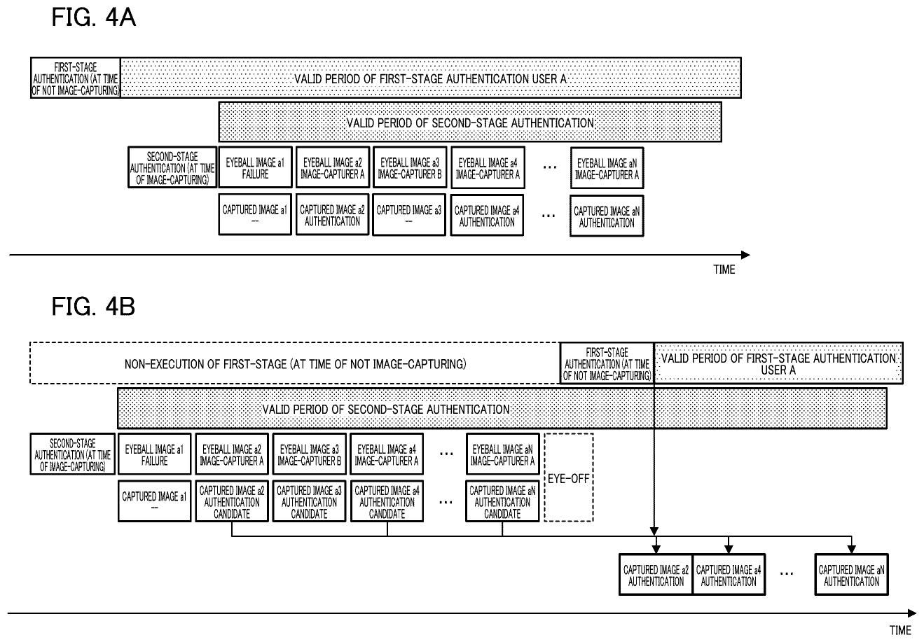

FIGS. 4A and 4B are schematic diagrams of a time-series process illustrating an authentication method according to this embodiment. FIG. 4A is a schematic diagram of a case in which the first-stage authentication is performed first and illustrates an image-capturer authentication granting method corresponding to the operations of S201 to S207 illustrated in FIG. 3. On the other hand, FIG. 4B is a schematic diagram of a case in which the second-stage authentication is performed first and illustrates an image-capturer authentication granting method corresponding to the operations of S102 to S110 illustrated in FIG. 3.

In FIG. 4A, first, the first-stage authentication is executed at the time of not image-capturing. Mr. A who is the user among registrants is identified through the first-stage authentication, and the valid period of the first-stage authentication having Mr. A as the user is set.

After the first-stage authentication, when the user places his or her eye on the electronic viewfinder 14 and enters an image-capturing operation, an eyeball image is acquired, and the second-stage authentication is executed. At the moment of image-capturing or almost simultaneously therewith, an eyeball image is acquired for each image-capturing, and user characteristics are extracted from the eyeball image and are compared with the registrant characteristics to identify the image-capturer.

For example, when an eyeball image a2 illustrated in FIG. 4A is identified to be that of Mr. A, the person identified through the first-stage authentication and the person identified through the second-stage authentication are regarded to be the same person. Then, image-capturer authentication assuring that image-capturing has been performed by Mr. A at that time point is granted to a captured image a2 corresponding to the eyeball image a2.

In a case in which identification from a registrant has failed through the second-stage authentication or the user is identified to be another registrant, for example, the following measures may be taken. In a case in which emphasis is placed on the result of the second-stage authentication, image-capturer authentication is not granted due to mismatch with the first-stage authentication to a captured image a1 corresponding to the eyeball image a1 for which identification from a registrant has failed. Similarly, also to a captured image a3 corresponding to the eyeball image a3 of which the image-capturer has been identified to be Mr. B who is a person different from Mr. A, image-capturer authentication is not granted due to mismatch with the first-stage authentication.

On the other hand, in a case in which emphasis is placed on the continuity or a cumulative number of results in which the image-capturer is identified to be Mr. A in the second-stage authentication, for example, the valid period of the second-stage authentication is set on a stage in which the threshold of the proportion of captured images for which Mr. A is identified is exceeded. During the valid period, the image-capturer may be identified to be Mr. A regardless of the result of the second-stage authentication (eyeball images a4 to aN illustrated in FIG. 4A). This valid period may be ended if it is determined that the current image-capturing operation has ended in accordance with placement of the eye away from the electronic viewfinder 14. The valid period may be ended in a case in which a person other than Mr. A is consecutively identified during image-capturing and the like. In this case, image-capturer authentication can be granted also to a captured image a3 that has not been authenticated in a case in which emphasis is placed on the result of the second-stage authentication.

In FIG. 4B, the first-stage authentication is not performed first, and an image-capturing operation is performed first, and the second-stage authentication is executed.

A captured image a1 corresponding to the eyeball image a1 for which the identification of the image-capturer has failed in the second-stage authentication is handled as not being authenticated. In addition, the captured image a2 corresponding to the eyeball image a2 identified to be Mr. A and the captured image a3 corresponding to the eyeball image a3 identified to be Mr. B are pre-marked as authentication candidates.

Here, the valid period of the second-stage authentication begins in accordance with the execution of the second-stage authentication. The captured image for which the user has been identified is, thereafter, maintained to be in a state in which the second-stage authentication has been achieved within the valid period of the second-stage authentication that has been arbitrarily set. However, since the second-stage authentication is authentication of which the identification accuracy is relatively low, the valid period of the second-stage authentication is set to be shorter than the valid period of the first-stage authentication.

Examples of the valid period of the second-stage authentication include, for example, a valid period, which begins in accordance with the execution of the second-stage authentication in a certain image-capturing operation, until the eye is placed away from the electronic viewfinder 14 once after the end of the image-capturing operation and the eye is placed on the electronic viewfinder 14 one more time for a next image-capturing operation and the like.

When the image-capturing operation ends, and the eye is away from the electronic viewfinder 14 once, the user is notified from the authentication display unit 109 that the first-stage authentication has not been achieved, and the user can execute the first-stage authentication at the time of not image-capturing.

Thereafter, when the user of the camera system 1 is identified to be Mr. A through the first-stage authentication, image-capturer authentication is granted using this result and the result of the second-stage authentication that is already been executed. In other words, image-capturer authentication is granted to captured images a2, a4, and the like of which the image-capturers are the same, who is Mr. A, in the second-stage authentication among captured images that are authentication candidates in the second-stage authentication. When the first-stage authentication is performed once, authentication for image-capturing operations performed thereafter may follow the sequence described in FIG. 4A.

In addition, captured images of which results of the second-stage authentication are other than Mr. A may be handled as below. As described above, in a case in which emphasis is placed on the result of the second-stage authentication, image-capturer authentication is not granted for captured images of which the results are other than Mr. A.

In a case in which the proportion of captured images identified to be Mr. A to captured images exceeds a threshold, even when the second-stage authentication has an identification result other than Mr. A, image-capturer authentication may be granted by regarding the result as Mr. A. However, image-capturer authentication may be granted by regarding the identification result to be Mr. A even when the second-stage authentication has an identification result other than Mr. A in a case in which the possibility of being the same person is assured to be high by performing the first-stage authentication within the valid period of the second-stage authentication.

The image-capturer authentication may be granted by assigning levels to the reliability of authentication from results of the first-stage authentication and the second-stage authentication. In such a case, authentication corresponding to the level may be granted also for a captured image for which the second-stage authentication has been executed and the first-stage authentication has not been executed. In other words, the authentication information may include information representing the degree of identification accuracy for an image-capturer (for example, a level of the reliability to be described below).

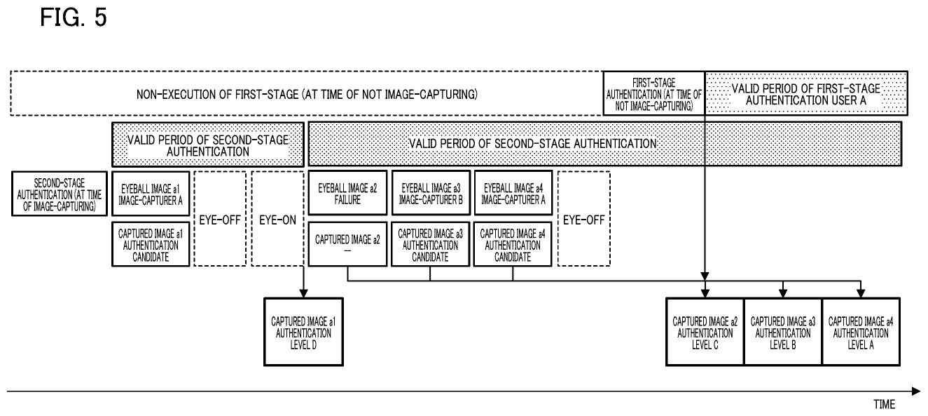

FIG. 5 is a schematic diagram of a time-series process illustrating an authentication method of a case in which a plurality of levels are provided in the authentication. Similar to FIG. 4B, also in FIG. 5, in a situation in which the first-stage authentication is not executed, first, an image-capturing operation is performed, and the second-stage authentication is executed.

In the image-capturing operation of the first time, the image-capturer is identified to be Mr. A from the eyeball image, and a corresponding captured image a1 is set as an authentication candidate. Then, although the valid period of the second-stage authentication begins, the user places his or her eye away from the electronic viewfinder 14 once, thereafter, does not perform execution of the first-stage authentication, and places his or her eye on electronic viewfinder again, and starts image-capturing. For this reason, the valid period of the second-stage authentication in the image-capturing operation of the first time is ended in accordance with the placement of the eye away from the electronic viewfinder.

In FIG. 4B, although the captured image a1 is excluded from authentication at this eye-off state, as illustrated in FIG. 5, by providing a level of the reliability in the authentication, the image-capturer authentication may be granted with this level being assigned. In the case of the captured image a1 described above, since the second-stage authentication has been successful in identification (Mr. A), and the first-stage authentication has not been executed, level D is assigned as the degree of reliability corresponding to the authentication details, and the image-capturer authentication is granted with the image-capturer being Mr. A.

Next, in an image-capturing operation of a second time illustrated in FIG. 5, a captured image a2 of which the identification of the image-capturer has been failed, a captured image a3 of which the image-capturer has been identified to be Mr. B, and a captured image a4 of which the image-capturer is identified to be Mr. A are acquired. Then, the first-stage authentication is executed within the valid period of the second-stage authentication, and the current user is identified to be Mr. A among registrants of the camera system 1, and the result is applied to the captured images a2 to a4.

In FIG. 4B, although the captured images a2 and a3 are excluded from the authentication targets at this time point, image-capturer authentication corresponding to the reliability is granted thereto in FIG. 5. This is based on the assumption that image-capturers of images acquired in the same image-capturing operation in the state in which the eye is on the electronic viewfinder 14 are the same regardless of the identification result. On that basis, by placing greater emphasis on the results of the second-stage authentication, the omission of each individual image is eliminated, and furthermore, for captured images authenticated at the highest level, the reliability regarding the authenticity is further improved.

In FIG. 5, levels are assigned to captured images a2 to a4 acquired in the image-capturing operation of the second time as below. Image-capturer authentication representing that the image-capturer is Mr. A is granted to the captured image a2 of which the second-stage authentication has resulted in an identification failure and the first-stage authentication has resulted in an identification success (Mr. A) with level C of which the reliability is higher than that of level D of the captured image a1 assigned.

In other words, the level of the reliability of a captured image for which the first-stage authentication and the second-stage authentication have been performed and of which the second-stage authentication has resulted in an authentication failure is higher than the level of the reliability of a captured image for which only the second-stage authentication has been performed.

In addition, image-capturer authentication representing that the image-capturer is Mr. A is granted to a captured image a3 of which the second-stage authentication has resulted in an identification success (Mr. B) and the first-stage authentication has resulted in an identification success (Mr. A) with a level that is equivalent to level C or level B of which the reliability is higher than that of level C assigned.

In other words, the level of the reliability of a captured image for which a person identified through the first-stage authentication and a person identified through the second-stage authentication are judged not to be the same person is equivalent to or higher than the level of the reliability of a captured image of which the first-stage authentication has been successful, and the second-stage authentication has failed.

In addition, since persons are identified to be the same person, image-capturer authentication representing that that image-capturer is Mr. A is granted to a captured image a4 of which the second-stage authentication has resulted in an identification success (Mr. A) and the first-stage authentication has resulted in an identification success (Mr. A) with level A of which the reliability is the highest assigned.

In other words, the level of the reliability of a captured image for which a person identified through the first-stage authentication and a person identified through the second-stage authentication are judged to be the same person is higher than the level of the reliability of a captured image for which a person identified through the first-stage authentication and a person identified through the second-stage authentication are judged not to be the same person.

Although a difference between level C and level B is set considering that it can be identified by at least Mr. B who is a registrant of the camera system 1, the level of a captured image for which the original user (Mr. A) has not been identified can be appropriately changed. In addition, the information representing the identification accuracy of an image-capturer is not limited to the types such as levels A to D and, for example, it may be a numerical value such as a score.

In this way, the information (level D) representing the degree of the identification accuracy included in a captured image for which only the second image-capturer authentication has been performed has an identification accuracy lower than the information (levels A to C) representing the degree of the identification accuracy included in a captured image for which the first image-capturer authentication and the second image-capturer authentication have been performed.

As above, although the embodiment of the present disclosure has been described, according to this embodiment, in the camera system 1 granting image-capturer authentication, it is possible to secure reliability that is sufficient for granting image-capturer authentication while a loss in image-capturing opportunities according to the authentication process is prevented.

### Second Embodiment

Next, a camera system 1 granting image-capturer authentication according to a second embodiment of the present disclosure is described. In this embodiment, the configuration of the camera system 1 and the authentication method for image-capturer authentication are similar to those of the first embodiment. In this embodiment, a mechanism that determines whether persons operating the camera system 1 before and after an image-capturing operation are the same is added. This relates to the setting of the valid period of the second-stage authentication.

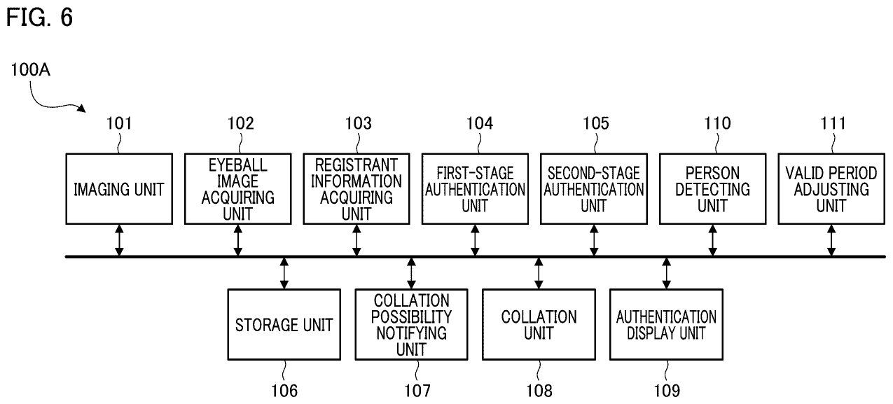

FIG. 6 illustrates an example of the mechanical configuration of an information processing device 100A included in the camera system 1 according to this embodiment. A person detecting unit 110 and a valid period adjusting unit 111 are added to the configuration according to the first embodiment described with reference to FIG. 2.

The person detecting unit 110 has a function of detecting a user (image-capturer) of the camera system 1. In other words, the person detecting unit 110 functions as an image-capturer detecting unit that detects an image-capturer. Examples of the person detecting unit 110 include a proximity sensor that detects eye-on/eye-off for the electronic viewfinder 14 included in the eyeball image acquiring unit 102, a fingerprint authentication sensor disposed in the release button 16, and the like. Furthermore, an in-camera that is disposed on the rear side of the body 12 and performs face detection of a user may be used.

The fingerprint authentication sensor may simply function as a more basic contact sensor. Similarly, the contact sensor may be provided on a grip part of the body 12.

The person detecting unit 110 may function before the user of the camera system 1 places his or her eye on the electronic viewfinder 14 and enters an image-capturing operation. For example, in a case in which eye-on has been detected by the proximity sensor, in a normal use situation, the user of the camera system 1 is assumed to be the same person until next eye-off. Similarly, in a case in which a user places a finger on the release button 16 or grips the grip part of the body 12 once, the use of the same person is assumed as long as that contact state continues.

In addition, the in-camera performs face detection of the user facing the rear side of the body 12 and can track and continue to detect the user's face as long as it is within the image-capturing range even if the face of the user moves. Although face detection itself cannot be performed in the process of the user whose face has been detected placing his or her eye on the electronic viewfinder 14, face detection can be performed again in the process of placing his or her eye away from the electronic viewfinder. These eye-on process and eye-off process can be analyzed from the image of the in-camera, and it can be detected that the user of the camera system 1 is the same person before and after eye-on/eye-off.

In this way, the person detecting unit 110 is configured using a part that can continuously detect a specific person (user).

In addition, the person detecting units 110 such as the contact sensor and the in-camera described above may be used in association with each other. For example, a case in which face detection using the in-camera and contact detection (including gripping) of the grip part of the body 12 are simultaneously performed in a non-image-capturing state is assumed. In a case in which the user moves the body 12 while gripping the grip part, and the in-camera no longer can capture the user, even when the face detection cannot be performed due to the position and the angle, the use of the same person is assumed while the contact detection continues. To the contrary, in a case in which the camera is suspended from the neck using a neck strap in a hand-off state, although contact detection cannot be performed, the use of the same person is assumed when face detection using the in-camera can be tracked.

In addition, the person detecting unit 110 may start detection triggered by the execution of the second-stage authentication at the time of performing an image-capturing operation. A person placing his or her eye on the electronic viewfinder 14 at the release timing of the second-stage authentication is regarded as the image-capturer, and detection of this image-capturer continues.

As long as the eye-on state according to the proximity sensor detected at the image-capturing timing continues, the same person is determined, and, similarly, as long as the detected gripping state of the body 12 according to the contact sensor continues, the same person is determined.

Furthermore, in a case in which the image-capturing operation is temporarily ended, and the eye is moved away from the electronic viewfinder 14, face detection using the in-camera can be performed at a timing at which it becomes impossible to perform detection using the proximity sensor. From this switching of detection in the process of moving the eye away, the identity of the person can be detected. The relation of this switching is similar also in the process of moving the eye on the electronic viewfinder 14.

The valid period adjusting unit 111 adjusts the valid period of the second-stage authentication according to the detection status of the user according to the person detecting unit 110. As described in the first embodiment, a captured image of which the image-capturer has been identified, thereafter, is maintained to be in a state in which the identification of the second-stage authentication has been completed within the valid period of the second-stage authentication that has been arbitrarily set.

In the first embodiment, in a case in which the user has ended the valid period by placing his or her eye on the electronic viewfinder 14 again without executing the first-stage authentication within the valid period of the second-stage authentication, a captured image maintained to be in the state in which the previous second-stage authentication has been achieved is excluded from targets for granting image-capturer authentication.

On the other hand, in this embodiment, from a timing before the valid period of the second-stage authentication is set or from a timing at which the valid period of the second-stage authentication is set, it is continuously detected by the person detecting unit 110 whether the user is the same person.

As long as the detection of the same person continuous, even when eye-on/eye-off for the electronic viewfinder 14 accompanying the end of an image-capturing operation have been repeated, the valid period adjusting unit 111 performs adjustment such that the valid period of the second-stage authentication can be continued (extended).

In a case in which the same person is no longer detected, the adjustment of the valid period of the second-stage authentication is regarded to temporarily end. In a case in which emphasis is placed on the detection result of the person detecting unit 110, at that time point, the valid period of the second-stage authentication itself may be cancelled. However, appropriately within the valid period, non-execution of the first-stage authentication is notified, and the execution of the first-stage authentication needs to be checked. In other words, the valid period adjusting unit 111 functions as a part of an information assigning unit and causes the valid period of the second image-capturer authentication to continue while the image-capturer detecting unit continuously detects the same image-capturer from the time of the second image-capturer authentication.

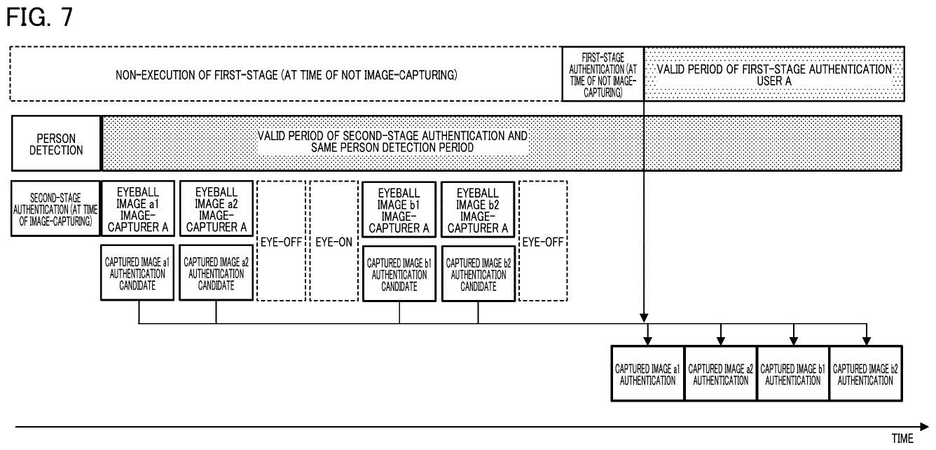

FIG. 7 is a schematic diagram of a time-series process illustrating an authentication method according to this embodiment. In FIG. 7, without executing the first-stage authentication, first, an image-capturing operation is performed, and the second-stage authentication is executed.

From a timing before the execution of the second-stage authentication or at a timing at which the second-stage authentication has been achieved, the person detecting unit 110 operates and continues to detect whether the person operating the camera system 1 is the same without being switched.

In FIG. 7, in a first image-capturing operation, captured images (a1, a2) corresponding to eyeball images (a1, a2) identified to be Mr. A are pre-marked as authentication candidate.

Thereafter, while the image-capturing operation is ended by placing the eye away from the electronic viewfinder 14 once, without performing the first-stage authentication, the eye is placed on the electronic viewfinder again to enter a next image-capturing operation. In this case, from continuous detection using the person detecting unit 110, it is determined that the user of the camera system 1 is the same person, and thus the valid period of the second-stage authentication continues without being interrupted. In other words, the pre-marked captured images (a1, a2) are maintained still as authentication candidates.

Similarly, also in the image-capturing operation of the second time, captured images (b1, b2) are pre-marked as being captured by Mr. A as authentication candidates.

After the end of the image-capturing operation of the second time, within the valid period of the second-stage authentication, non-execution of the first-stage authentication is notified to the image-capturer (user) again, and the image-capturer executes the first-stage authentication at the time of not image-capturing.

When the user of the camera system 1 is identified to be Mr. A through the first-stage authentication, this result is applied to results of the second-stage authentication performed in a plurality of previous image-capturing operations. In other words, image-capturer authentication is granted to the captured images (a1, a2 and b1, b2) of which image-capturers of the second-stage authentication are the same as Mr. A among captured images that become authentication candidates in the second-stage authentication. In addition, captured images for which the result of the second-stage authentication is other than Mr. A may be handled similar to the first embodiment. When the first-stage authentication is performed once, an authentication method after that may follow the sequence described with reference to FIG. 4A.

In this way, for example, even in a case in which eye-off and eye-on for the electronic viewfinder 14 are repeated, in a case in which the user of the camera system 1 is assured to be the same person, the valid period can be set to be continued in the assured range.

According to the embodiment of the present disclosure, in the camera system 1 granting image-capturer authentication, it is possible to secure reliability that is sufficient for granting image-capturer authentication while a loss in image-capturing opportunities according to the authentication process is prevented.

In addition, in this embodiment, even when a plurality of image-capturing operations are repeated while accompanying eye-off and eye-on, it can be determined that the camera operator is the same person. The degree of freedom in the execution timing of the subsequent first-stage authentication is increased, which leads to improved convenience for the user.

### Third Embodiment

Next, a camera system granting image-capturer authentication according to a third embodiment of the present disclosure is described. In this embodiment, the configuration of the camera system 1 and the authentication method for image-capturer authentication are similar to those of the first embodiment. In this embodiment, a specific example of the authentication display unit 109 is described.

The authentication display unit 109 displays notification of an authentication status, confirmation of authentication execution, a graphical user interface (GUI) for authentication execution and the like.

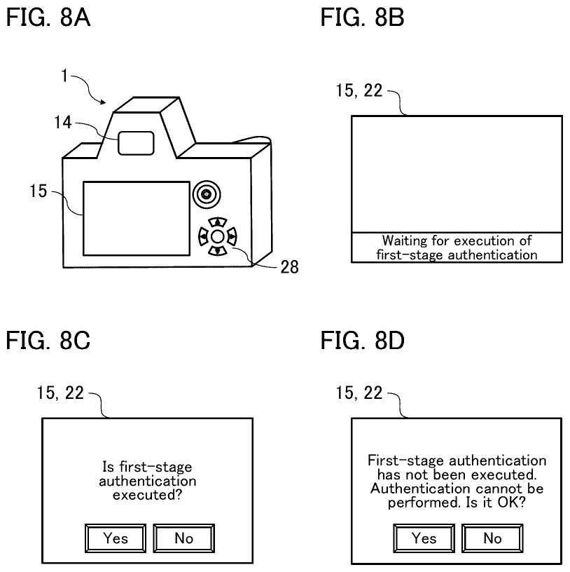

FIGS. 8A and 8D illustrate the configuration and an operation example of the authentication display unit 109 according to this embodiment. FIG. 8A is a configuration example of the authentication display unit 109 of the camera system 1, and notification relating to authentication to the user is performed using displays in the electronic viewfinder 14 (more specifically, an electronic viewfinder display 22) and the touch panel display 15. The touch panel display 15 is used when the user has his or her eye placed away from the electronic viewfinder 14, and the electronic viewfinder display 22 is used when the user has the eye placed on the electronic viewfinder.

In a case in which the touch panel display 15 is used, the selection of a GUI relating to authentication becomes an operation using a touch panel of the touch panel display 15 or a controller 28 disposed in the body 12. In a case in which the electronic viewfinder display 22 is used, the selection becomes an operation using the controller 28. Alternatively, the selection may be the user's line of sight, the user's voice, or an operation from an external device capable of operating the camera system 1.

FIGS. 8B and 8D illustrate examples of notification to the user using the authentication display unit 109. For example, in FIG. 8B, a state in which the first-stage authentication is waiting for execution, that is, identification and authentication of the user of the camera system 1 having not been performed is notified.

The timing of the notification may be from the start-up of the camera system 1 or from the start of the valid period of the second-stage authentication, or may be appropriately selected. By checking the notification illustrated in FIG. 8B, the user recognizes that the first-stage authentication has not been executed and can start the execution of the first-stage authentication as needed. In other words, in a case in which the first image-capturer authentication has not been performed at the time of beginning the valid period of the second image-capturer authentication, the authentication display unit 109 displays that the first image-capturer authentication has not been performed.

At a time point at which the user is identified by executing the first-stage authentication, the details of the notification may be changed. The notification itself may be canceled or not displayed to return to the normal display mode or may be switched to give a notification of a state in which the first-stage authentication has been executed. Furthermore, the notification may be presented not only as a text string but may be replaced with an icon or the like conveying the same meaning.

For example, in FIG. 8C, the user is allowed to confirm the selection of the execution of the first-stage authentication. This confirmation may be displayed, for example, at a timing at which the user moves his or her eye away from the electronic viewfinder 14 within the valid period of the second-stage authentication.

Among “Yes” and “No” command buttons, when the user selects “Yes,” that command is notified, and the camera system 1 starts executing the first-stage authentication. Also, instead of selection of “Yes” and “No”, a command button directly starting the first-stage authentication may be displayed as a GUI. Further, for example, the text string waiting for the execution illustrated in FIG. 8B may be handled as a command button.

For example, in FIG. 8D, the user is allowed to confirm stop of granting image-capturer authentication and discard of the image-capturer authentication according to non-execution of the first-stage authentication. This confirmation may be displayed, within the valid period of the second-stage authentication, for example, during a transition period entering an operation that invalidates the previous second-stage authentication in the status in which the first-stage authentication has not been executed.

Among the “Yes” and “No” commands, when the user selects “Yes”, the camera system 1 discards granting of image-capturer authentication to the previously-acquired image and causes the process to proceed to a next operation. This notifies the user that the first-stage authentication has not been executed and entrusts to the user's discretion whether to disable granting of image-capturer authentication.

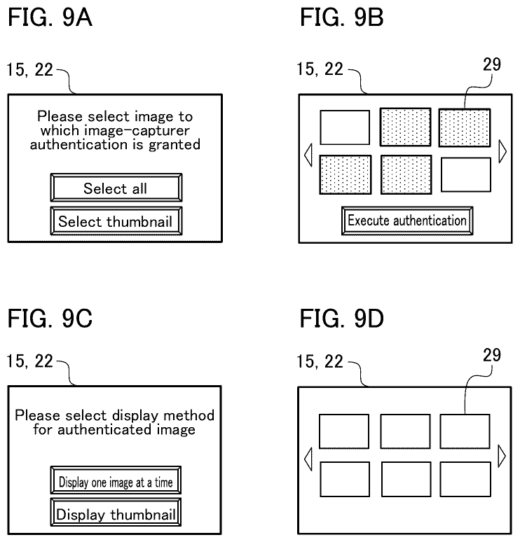

FIGS. 9A and 9D illustrate another operation example of the authentication display unit 109 according to this embodiment. FIGS. 9A and 9B illustrate specific examples of a GUI used when executing the first-stage authentication subsequently after executing the second-stage authentication and operation examples thereof. The selection of commands on the screens illustrated in FIGS. 9A and 9B may be performed either before or after the execution of the first-stage authentication. As illustrated in FIGS. 9A and 9D, the touch panel display 15 functions as a selection unit for selecting a plurality of captured images displayed on the display unit. In addition, the selection unit may be the controller 28 illustrated in FIGS. 8A and 8D.

In FIGS. 9A and 9D, before executing the first-stage authentication, the user can select a captured image to which image-capturer authentication is desired to be granted among captured images for which the second-stage authentication has been performed. For example, in FIG. 9A, at the time of execution of the first-stage authentication, the selection of a captured image to which image-capturer authentication is desired to be granted is entrusted to the user. In other words, the first authentication unit performs the first image-capturer authentication for the captured image selected by the selection unit.

When the user executes a “Select All” command, all the captured images within the valid period of the second-stage authentication are handled as targets. Thereafter, when the first-stage authentication is executed, the result is applied. The granting of image-capturer authentication based on the results of the second-stage authentication and the first-stage authentication is performed in accordance with the authentication method described in FIG. 4B or FIG. 5.

Furthermore, when the user executes a “Thumbnail Selection” command, for example, as illustrated in FIG. 9B, captured images acquired in advance within the valid period are displayed as thumbnails 29. The user the executes the first-stage authentication by appropriately selecting a thumbnail desired to be a target from a plurality of thumbnails 29 and then selecting an “Execute Authentication” command. The results of the first-stage authentication are applied only to the captured images selected via the thumbnails, and image-capturer authentication is collectively granted in accordance with the authentication method. Furthermore, also captured images that have not been previously selected via the thumbnails can be handled as targets for image-capturer authentication in accordance with a selection process that is re-performed when it is within the valid period of the second-stage authentication.

Furthermore, as another method illustrated in FIGS. 9A and 9B, the user can select a captured image to which image-capturer authentication is desired to be granted after executing the first-stage authentication. The second-stage authentication and the first-stage authentication are executed, and image-capturer authentication may be assigned together to captured images that are targets for granting image-capturer authentication in accordance with “Select All”. Alternatively, after thumbnails that are desired to be targets are appropriately selected from “Thumbnail Selection”, image-capturer authentication may be granted only to captured images that have been selected using the “Execute Authentication” command.

Furthermore, FIGS. 9C and 9D illustrate specific examples of the method of displaying captured images to which image-capturer authentication has already been granted. For example, in FIG. 9C, the selection of a display method for captured images to which image-capturer authentication has been granted is entrusted to the user.

The user may, for example, select commands such as “Display One by One” or “Thumbnail Display.” In a case in which “Thumbnail Display” is selected, for example, as illustrated in FIG. 9D, captured images to which image-capturer authentication has been granted are displayed in a list, and the user can read the captured images.

In this embodiment, determination of the execution of image-capturer authentication is entrusted to the user in this way, and the user can select the captured images to which image-capturer authentication is desired to be granted. Thus, a selection option for not granting image-capturer authentication to captured images of low values for a user can be given to the user. By excluding captured images of low values, it is possible to suppress an increase in the processing load (a processing time, power consumption, memory usage, and the like) accompanying image-capturer authentication in the camera system 1. Furthermore, by excluding captured images of low values, the efficiency of managing and searching captured images to which image-capturer authentication has been granted can also be improved.

In the above-described embodiment, the user characteristics are acquired from the eyepiece images at the time of image-capturing using a camera. Furthermore, an example in which, after authentication of the user (image-capturer), image-capturer information is granted to the captured images in a form that cannot be altered has been illustrated. However, the present disclosure is not limited to this example, and any implementation form may be used as long as the spirit of the disclosure is realized.

### Other Embodiments

The present disclosure can be realized also in a process in which a program realizing one or more functions of the embodiment described above is supplied to a system or a device through a network or a storage medium, and one or more processors of a computer of the system or the device read and execute the program. Furthermore, the present disclosure can be realized also using a circuit (for example, an ASIC) that realizes one or more functions.

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

As above, while embodiments of the present disclosure have been described, the present disclosure is not limited to such embodiments, and various modifications and changes can be made within the range of the gist.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, reliability that is sufficient for granting image-capturer authentication can be secured while a loss in image-capturing opportunities according to an authentication process is prevented.

This application claims the benefit of Japanese Patent Application No. 2024-210073, filed Dec. 3, 2024, which is herein in its entirety.

What is claimed is:

1. An information processing device comprising:
a captured image acquiring unit configured to acquire a captured image;
at least one memory storing instructions; and
at least one processor executing the stored instructions causing the information processing device to:
perform first image-capturer authentication at the time of the captured image not being captured;
perform second image-capturer authentication at the time of the captured image being captured; and
assign authentication information of an image-capturer to the captured image acquired by the captured image acquiring unit on the basis of a result of the first image-capturer authentication and a result of the second image-capturer authentication,
wherein executing the stored instructions by the processor further causes the information processing device to: in a case in which the second image-capturer authentication has been performed without performing the first image-capturer authentication, perform the first image-capturer authentication within a valid period of the second image-capturer authentication that is set after the second image-capturer authentication; and assign the authentication information when the image-capturer is able to be identified through the first image-capturer authentication.

2. The information processing device according to claim 1, wherein the first image-capturer authentication is an authentication method using biometric information of the image-capturer.

3. The information processing device according to claim 1, wherein the first image-capturer authentication is an authentication method using non-biometric information.

4. The information processing device according to claim 1, wherein a person identification accuracy according to the second image-capturer authentication is lower than a person identification accuracy according to the first image-capturer authentication.

5. The information processing device according to claim 1, wherein executing the stored instructions by the processor further causes the information processing device to: in a case in which the first image-capturer authentication is performed, and the image-capturer has been identified through the first image-capturer authentication, when the second image-capturer authentication is performed within a valid period of the first image-capturer authentication that is set after the first image-capturer authentication, assign the authentication information.

6. The information processing device according to claim 5, wherein the valid period of the first image-capturer authentication is a period longer than the valid period of the second image-capturer authentication.

7. The information processing device according to claim 1, wherein the authentication information includes information representing a degree of identification accuracy of the image-capturer.

8. The information processing device according to claim 7, wherein, in the information representing the degree of the identification accuracy included in the captured image for which only the second image-capturer authentication has been performed, information representing that the identification accuracy of the image-capturer is lower than the information representing the degree of the identification accuracy included in the captured image for which the first image-capturer authentication and the second image-capturer authentication have been performed, is set.

9. The information processing device according to claim 1, further comprising an image-capturer detecting unit configured to detect an image-capturer,
wherein executing the stored instructions by the processor further causes the information processing device to cause the valid period of the second image-capturer authentication to continue while the image-capturer detecting unit continuously detects the same image-capturer from the time of the second image-capturer authentication.

10. The information processing device according to claim 9, wherein the image-capturer detecting unit is configured using one or more of a proximity sensor that detects approach of the image-capturer, a contact sensor that detects contact of the image-capturer, and an imaging device capable of imaging at least a face of the image-capturer.

11. The information processing device according to claim 1, further comprising a display unit configured to display information,
wherein, in a case in which the first image-capturer authentication has not been performed at the time of beginning the valid period of the second image-capturer authentication, the display unit displays that the first image-capturer authentication has not been performed.

12. The information processing device according to claim 11,
wherein the display unit displays a plurality of captured images, and
wherein executing the stored instructions by the processor further causes the information processing device to: select a captured image from the plurality of captured images displayed on the display unit; and perform the first image-capturer authentication for the selected captured image.

13. The information processing device according to claim 12, wherein the plurality of captured images are displayed on the display unit in a thumbnail form.

14. An information processing method executed by an information processing device, the information processing method comprising:
acquiring a captured image;
performing first image-capturer authentication at the time of the captured image not being captured;
performing second image-capturer authentication at the time of the captured image being captured; and
assigning authentication information of an image-capturer to the acquired captured image on the basis of a result of the first image-capturer authentication and a result of the second image-capturer authentication,
wherein, in the assigning the authentication information to the captured image, in a case in which the second image-capturer authentication has been performed without performing the first image-capturer authentication, the first image-capturer authentication is performed within a valid period of the second image-capturer authentication that is set after the second image-capturer authentication, and the authentication information is assigned when the image-capturer is able to be identified through the first image-capturer authentication.

15. A non-transitory storage medium storing a program of an information processing device, causing a computer to perform each step of an information processing method executed by the information processing device, the method comprising:
acquiring a captured image;
performing first image-capturer authentication at the time of the captured image not being captured;
performing second image-capturer authentication at the time of the captured image being captured; and
assigning authentication information of an image-capturer to the acquired captured image on the basis of a result of the first image-capturer authentication and a result of the second image-capturer authentication,
wherein, in the assigning the authentication information to the captured image, in a case in which the second image-capturer authentication has been performed without performing the first image-capturer authentication, the first image-capturer authentication is performed within a valid period of the second image-capturer authentication that is set after the second image-capturer authentication, and the authentication information is assigned when the image-capturer is able to be identified through the first image-capturer authentication.
